(19) United States
(12) Patent Application Publication
(10) Pub. No.: US 2019/0213048 A1
(43) Pub. Date: Jul. 11, 2019

(54) DEVICE NETWORK FOR INCENTIVIZED MINING UTILIZING LEVERAGED COMPUTING RESOURCES WITHIN A BLOCK CHAIN ARCHITECTURE

(71) Applicant: William Bohannon Mason, San Francisco, CA (US)

(72) Inventor: William Bohannon Mason, San Francisco, CA (US)

(21) Appl. No.: 16/246,024

(22) Filed: Jan. 11, 2019

Related U.S. Application Data
(60) Provisional application No. 62/616,259, filed on Jan. 11, 2018.

(51) Int. Cl. G06F 9/50; H04L 29/08; H04L 29/06; G06F 9/54; H04L 9/06; G06Q 30/02; H04W 76/10

(52) U.S. Cl. CPC G06F 9/5072; H04L 67/025; H04L 67/125; H04L 67/32; H04L 67/10; H04L 63/10; G06F 2209/503; H04L 9/0637; G06Q 30/0207; H04W 76/10; H04L 2209/38; G06F 2209/549; G06F 9/54

(57) ABSTRACT

Embodiments are directed to a system and method implementing networked devices for utilizing leveraged computing resources within a content delivery platform. The system is configured to establish a communication channel with a user device over the network; receive a request from the user device to access requested content; in response to receiving the request from the user device, provide the user device with access to the requested content; calculate idle computing resources of the user device not used by the user device to access the requested content; and based on calculating the idle computing resources of the user device and receiving the request, leverage the idle computing resources to execute an operation on a block chain.

### CROSS-REFERENCE TO RELATED APPLICATIONS

This application is a non-provisional filing of U.S. Provisional Application No. 62/616,259 filed Jan. 11, 2018 and titled Device Network for Incentivized Mining Utilizing Leveraged Computing Resources within a Block Chain Architecture, the contents of which are hereby incorporated by reference herein.

### BACKGROUND

Online content providers such as news organizations, video streaming services, application developers, and the like typically rely on advertisements and web-traffic to monetize their products and sustain growth. It is common practice for some content providers to attempt to entice increased traffic by intentionally presenting exaggerated or misleading content to users in an effort to garner additional clicks and viewings of advertisements. While potentially effective in the short-term, this strategy not only results in low-quality, “clickbait” content, but also results in poor user engagement with said content and leads to user attrition over time. As a result, there is a need for a content monetization system that is beneficial to both the content provider and user base of said content.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address these and/or other needs by providing an innovative system, method and computer program product for leveraging of networked user devices within a content access platform for incentivized mining-level participation on a block chain for enhanced user-content interaction. Embodiments of the invention relate to systems, methods, and computer program products for implementing networked devices for incentivized mining via leveraged computing resources within a content delivery platform.

A system implementing networked devices for utilizing leveraged computing resources within a content delivery platform is provided. The system comprises a memory device with computer-readable program code stored thereon; a communication device connected to a network; and a processing device operatively coupled to the memory device and the communication device. The processing device is configured to execute the computer-readable program code to: establish a communication channel with a user device over the network; receive a request from the user device to access requested content; in response to receiving the request from the user device, provide the user device with access to the requested content; calculate idle computing resources of the user device not used by the user device to access the requested content; and based on calculating the idle computing resources of the user device and receiving the request, leverage the idle computing resources to execute an operation on a block chain.

In one embodiment, leveraging the idle computing resources further comprises: transmitting instructions for executing the operation to the user device; and remotely controlling the idle computing resource of the user device over the network to execute the operation. In another embodiment, the idle computing resources of the user device comprise hardware installed in the user device configured for executing the operation. In yet another embodiment, the hardware of the user device comprises a central processing unit, a graphics processing unit, a field-programmable gate array, an application-specific integrated circuit, or a memory. In yet another embodiment, the hardware installed in the user device is a discrete hardware device configured only for dedicated execution of the operation on the block chain.

In yet another embodiment, the operation is a background operation executed autonomously by the idle computing resources of the user device without requiring user interaction with the user device. In yet another embodiment, the processing device is further configured to execute the computer-readable program code to only leverage the idle computing resources of the user device while the user device is accessing the requested content. In yet another embodiment, an amount of leveraged idle computing resources is dependent on a user demand for the idle computing resources and other processes executed by user device, wherein execution of the operation using the leveraged idle computing resources does not interfere with execution the other processes. In yet another embodiment, the processing device is further configured to execute the computer-readable program code to continuously recalculate the idle computing resources during execution of the operation.

In yet another embodiment, the processing device is further configured to execute the computer-readable program code to prevent the user device from accessing the requested content in response to termination of the communication channel. In yet another embodiment, the processing device is further configured to execute the computer-readable program code to continue leveraging the idle computing resources of the user device when the user device is in an inactive state and the user device is not assessing the requested content. In yet another embodiment, the processing device is further configured to execute the computer-readable program code to leverage the idle computing resources during a predetermined period when the user device is not accessing the requested content. In yet another embodiment, the user device is a first user device, and wherein the processing device is further configured to execute the computer-readable program code to calculate and leverage computing resources of a second user device instead of or in addition to the idle computing resources of the first user device while the user accessing the requested content on the first user device.

In yet another embodiment, the processing device is further configured to execute the computer-readable program code to leverage the user device as a miner node and leverage the idle computing resources of the user device to validate a pending block on the block chain. In yet another embodiment, executing the operation generates a reward, and wherein the system is further configured to store at least a portion of the reward.

A method for implementing networked devices for utilizing leveraged computing resources within a content delivery platform is also provided. The method comprises establishing a communication channel with a user device over a network; receiving a request from the user device to access requested content; in response to receiving the request from the user device, providing the user device with access to the requested content; calculating idle computing resources of the user device not used by the user device to access the requested content; and based on calculating the idle computing resources of the user device and receiving the request, leveraging the idle computing resources to execute an operation on a block chain.

In one embodiment, leveraging the idle computing resources further comprises: transmitting instructions for executing the operation to the user device; and remotely controlling the idle computing resource of the user device over the network to execute the operation. In another embodiment, leveraging the idle computing resources of the user device further comprises controlling hardware installed in the user device configured for executing the operation.

A system implementing networked devices for utilizing leveraged computing resources within a content delivery platform is also provided. The system comprises a memory device with computer-readable program code stored thereon; a communication device connected to a network; and a processing device operatively coupled to the memory device and the communication device. The processing device is configured to execute the computer-readable program code to: establish a communication channel with a first user device over the network; receive a request from the first user device to access requested content; in response to receiving the request from the first user device, provide the first user device with access to the requested content; based on receiving the request and providing the first user device with access to the requested content, leverage the computing resources of a second user device to execute an operation

In one embodiment, the processing device is further configured to execute the computer-readable program code to: calculate idle computing resources of the first user device, and leverage the idle computing resources of the first user device with the computing resources of the second user device to execute the operation.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a high level process flow illustrating leveraging of networked user devices within a content access platform for mining-level participation on a block chain, in accordance with one embodiment of the invention;

FIG. 2 provides an incentivized mining device network system environment, in accordance with one embodiment of the invention;

FIG. 3 provides a block diagram of a user device, in accordance with one embodiment of the invention;

FIG. 4 provides a block diagram of the block chain distributed network system, in accordance with one embodiment of the invention;

FIG. 5A provides a centralized database architecture environment, in accordance with one embodiment of the invention;

FIG. 5B provides a high level block chain system environment architecture, in accordance with one embodiment of the invention;

FIG. 6 provides a high level process flow illustrating node interaction within a block chain system environment architecture, in accordance with one embodiment of the invention;

FIG. 7 provides a high level block chain system architecture, in accordance with one embodiment of the invention;

FIG. 8 provides a high level process flow illustrating leveraging user device computing resources for block chain mining, in accordance with one embodiment of the invention;

FIG. 9 provides a diagram of a centralized content collection platform, in accordance with one embodiment of the invention; and

FIG. 10 provides a video game incentivized reward mining system environment, in accordance with one embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

Furthermore, as used herein the term “user device” or “mobile device” may refer to any device that employs a processor and memory and can perform computing functions, such as a personal computer or a mobile device, wherein a mobile device is any mobile communication device, such as a cellular telecommunications device (i.e., a cell phone or mobile phone), personal digital assistant (PDA), a mobile Internet accessing device, or other mobile device. Other types of mobile devices may include portable digital assistants (PDAs), pagers, wearable devices, mobile televisions, gaming devices, laptop computers, cameras, video recorders, audio/video player, radio, global positioning system (GPS) devices, or any combination of the aforementioned. In some embodiments, a device may refer to an entity's computer system, platform, servers, databases, networked devices, or the like. The device may be used by the user to access the system directly or through an application, online portal, internet browser, virtual private network, or other connection channel. The device may be a computer device within a network of connected computer devices that share one or more network storage locations.

As used herein, the term “computing resource” or “computing hardware” may be used to refer to elements of one or more computing devices, networks, or the like available to be used in the execution of tasks or processes. A computing resource may include processor, memory, or network bandwidth and/or power used for the execution of tasks or processes. A computing resource may be used to refer to available processing, memory, and/or network bandwidth and/or power of an individual computing device as well a plurality of computing devices that may operate as a collective (e.g., cloud computing) for the execution of one or more tasks (e.g., one or more computing devices operating in unison or nodes of a distributed computing cluster).

A “user” as used herein may refer to any individual or entity associated with the system. In some embodiments, a user may be a computing device user, a phone user, a mobile device application user, a content consumer or customer, a content platform provider, and/or employee of the provider. In some embodiments, identities of an individual user may include online handles, usernames, identification numbers (e.g., Internet protocol (IP) addresses), aliases, family names, maiden names, nicknames, or the like.

As used herein, the term “entity” may be used to include any organization or collection of users that may interact with the system. An entity may refer to a business, company, or other organization that either maintains or operates the system or requests use and accesses the system. In some embodiments, an entity may refer to a business that generates and/or provides content (e.g., news, video, audio, interactive media (e.g., video games), or the like) to a user base.

As used herein, the term “content” may refer to any text, audio, video, application, and/or other forms of interactive media, either physical or electronic, generated and/or provided to a consumer. Content may include text or written media, news, articles, magazines, blogs, social media posts, books, eBooks, songs, recordings, broadcasts, images, videos, live streams, advertisements, video games, performances, interactive media, and the like. Electronic or digital content may be provided via a computing device such as the user device as described herein. A “content provider,” as used herein, may refer to an individual or entity (e.g. a user, marketing entity, advertiser, author, composer, artist, developer, or the like) that generates and publishes content to a user base for consumption.

The terms “block chain,” “blockchain,” or “distributed ledger,” as used herein, refer to a decentralized electronic ledger of data records which are authenticated by a federated consensus protocol. Multiple computer systems within the block chain, referred to herein as “nodes” or “compute nodes,” each comprise a copy of the entire ledger of records. Nodes may write a data “block” to the block chain, the block comprising data regarding a transaction, said blocks further comprising data and/or metadata. In some embodiments, only miner nodes may write transactions to the block chain. In other embodiments, all nodes have the ability to write to the block chain. In some embodiments, the block may further comprise a time stamp and a pointer to the previous block in the chain. In some embodiments, the block may further comprise metadata indicating the node that was the originator of the transaction. In this way, the entire record of transactions is not dependent on a single database which may serve as a single point of failure; the block chain will persist so long as the nodes on the block chain persist. A “private block chain” is a block chain in which only authorized nodes may access the block chain. In some embodiments, nodes must be authorized to write to the block chain. In some embodiments, nodes must also be authorized to read from the block chain. Once a transactional record is written to the block chain, it will be considered pending and awaiting authentication by the miner nodes in the block chain.

A “block” as used herein may refer to one or more records of a file with each record comprising data for transmission to a server. In some embodiments, the term record may be used interchangeably with the term block to refer to one or more transactions or data within a file being transmitted. In particular, the block chain begins with a genesis block and is subsequently lengthened by appending blocks in series to the genesis block. Generally, the data within each block within the block chain may not be modified by the nodes of the block chain; data may only be added through the addition of a block to the last block in the block chain. Each block added to the block chain may comprise a timestamp and a pointer to the previous block in the block chain. In this way, the block chain may provide an immutable record of data records over a period of time. In some embodiments, in order for a new block to be added to the block chain, a pending data record may be proposed to be added to the block chain. The nodes may then, via a “consensus algorithm” or “consensus mechanism,” come to a consensus as to the contents of the data in the block chain. Once a consensus has been reached by the nodes that the pending data record is valid, the nodes append the data record to the last block in the block chain. In this way, each node maintains a validated copy of the block chain such that the block chain may remain accessible even if one or more nodes become unavailable (e.g. a node is offline due to maintenance, malfunction, etc.) and may further account for divergence from the true copy of the block chain which may occur at the node level (e.g. a copy of the block chain on a particular node becomes invalid due to data corruption, malicious editing, and the like). In other words, the consensus mechanism ensures that, over time, each node hosts a copy of the block chain that is consistent with the other nodes.

Embodiments of the invention as described herein may utilize one, several, or a combination (i.e. hybrid) of a number of different consensus algorithms to ensure the integrity of the data within the block chain. In some embodiments, the consensus mechanism may be a “proof of work” (“PoW”) algorithm, in which the nodes perform a series of calculations to solve a cryptographic puzzle. For instance, in order to validate a pending data record, the nodes may be required to calculate a hash via a hash algorithm (e.g. SHA256) which satisfies certain conditions set by the system. Calculating a hash in this way may be referred to herein as “mining,” and thus a node performing the mining may be referred to as “miners” or “miner nodes.”

“Miner node” as used herein refers to a networked computer system or device that authenticates and verifies the integrity of pending transactions on the block chain. The miner node ensures that the sum of the outputs of the transaction within the block matches the sum of the inputs. In some embodiments, a pending transaction may require validation by a threshold number of miner nodes. Once the threshold number of miners has validated the transaction, the block becomes an authenticated part of the block chain. By using this method of validating transactions via a federated consensus mechanism, duplicate or erroneous transactions are prevented from becoming part of the accepted block chain, thus reducing the risk of data record tampering and increasing the security of the transactions within the system. In some embodiments, one or more user devices may function as miner nodes within the system.

Embodiments of the invention provide a technical solution to a problem by utilizing computing devices in non-conventional, non-obvious ways. By discreetly leveraging unused, idle computing resources of user devices to, for example, mine cryptocurrency or execute other operations while the user is accessing content (e.g., reading a news article, streaming video, playing a video game), the system is able to provide an alternative method for monetizing the content generated by the participating entity through implementation of the unique technical solution described herein.

As generated rewards or currency can be shared with users accessing the content, the system incentivizes user engagement with the content. This allows for participating entities to avoid typical advertisement incorporation and “clickbait”-focused content creation and instead to focus on providing higher quality and valued content to the user in order to garner further prolonged user engagement and maximize the benefits of the unique monetization methods provided by invention.

Further, by eliminating misleading content, such as deceptive article titles, which can prove frustrating to a user attempting to interact with content, a user's view of the participating entity may be improved encouraging further patronage. Additionally, due to the increased user involvement and engagement with content, the described system may also be used as a compliment to traditional advertisement. Incentivized and prolonged engagement with content increases user exposure to traditional advertisements, as the user is more likely to spend more time engaged with the content. For example, a user is more likely to see and be impacted by an advertisement embedded in an online news source with which the user is incentivized to have prolonged interaction. In these ways, content providers, content consumers, and traditional advertisers may all benefit from the invention.

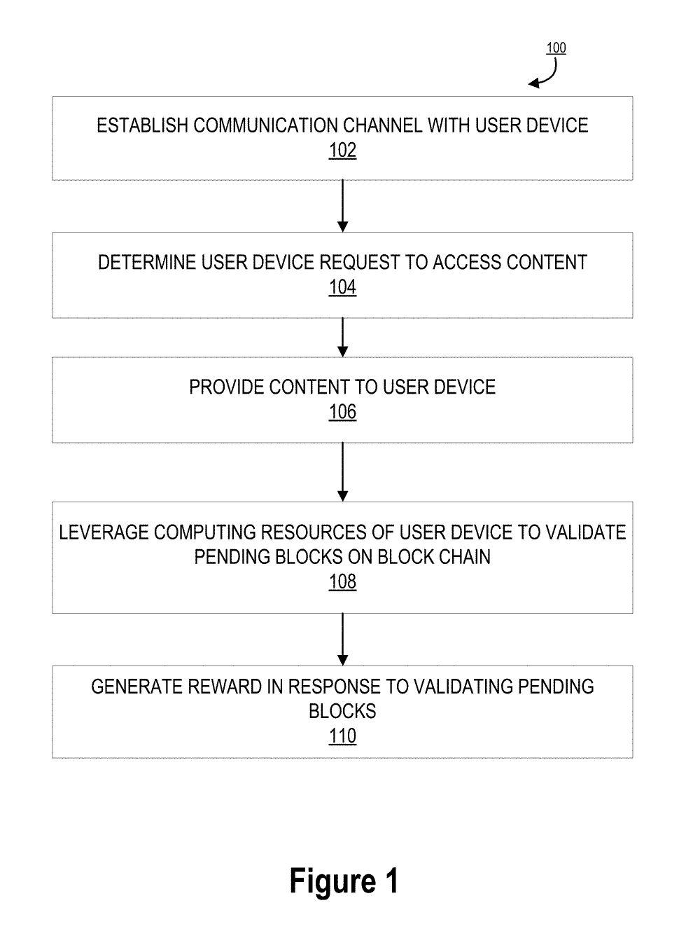

FIG. 1 provides a high level process map illustrating the leveraging of networked user devices within a content access platform for mining-level participation on a block chain 100, in accordance with one embodiment of the present invention. As illustrated in block 102, the process 100 is initiated by first establishing a communication channel with the user device. The communication channel may be established via a network to allow for transmitting and receiving of electronic communications and instructions between devices. The communication channel may further allow for the transmission of content (e.g., text, video, audio, applications, or other interactive media) from participating entities' systems to the user device, wherein the user is able to view and interact with the content on the user device. In some embodiments, the communication channel may be established when a user navigates to a location of a participating entity, such as a webpage or application associated with the participating entity. In some embodiments, the communication channel may be established upon installation of an application, software client, or other program on the user device.

In some embodiments, user-permission is required to first establish the communication channel between the user device and the system. Additionally or alternatively, user permission may be required before leveraging the computing resources of the user device for participation on the block chain. The system may present the user with terms and conditions of computing resource usage by the system. The terms and conditions of device usage must be agreed upon by the user before participation on the block chain can occur. In this way, the user is not covertly taken advantage of by the system and instead may enter into a mutually beneficial agreement, wherein the user may be incentivized by content access and/or earned rewards in exchange for usage of computing resources associated with the user device for the purpose of mining.

As illustrated in block 104, the system determines a request from the user device to access content over the established communication channel. As previously discussed, provided content includes text (e.g., articles, eBooks, newsfeeds, social media posts), video (e.g., video streams, downloadable video, television and movie rentals/purchases), audio (e.g., audiobooks and music files), interactive media (e.g., video games and applications), and other electronic media and files. The content is provided to the user device from those third party systems of entities participating within the ecosystem of the networked device incentivized mining system described herein. In some embodiments, the content may be stored on the systems of the participating entities while access to said content by the user devices may be managed by another source. A request from the user device to access content may comprise the user device navigating to a location of a participating entity, such as a webpage or application associated with the participating entity. The request from the user device to access content may also comprise user interaction with one or more objects or fields within a location of the participating entity. For example, a user may click a link to a news article, wherein the user interaction with the link indicates the request to access the content.

As illustrated in block 106 of FIG. 1, the system next provides the content to the user device. Providing the content to the user device may include, for example, allowing access to an article, streaming video to the user device, installing and/or operating an application on the user device, and the like. However, as illustrated in block 108, while providing said requested content to the user device, the system further leverages computing resources of the user device on a block chain distributed ledger. In a specific embodiment of the invention, the system remotely accesses and controls computing resources such as the central processing unit (CPU), graphics processing unit (GPU), and/or memory. The user device may be operated by the system as a miner node to add or validate pending blocks on the block chain while the user is accessing the provided content. In one embodiment, the system may require installation of a separate application or client on the user device that is specifically configured for controlling user device computing resources for mining operations. The separate application or client may operate autonomously through communication with the system over the network without requiring additional interaction with the user on the user device. It should be understood that a plurality of user devices operated by a plurality of users may be simultaneously leveraged to maximize processing capability on the block chain.

Finally, as illustrated in block 110, the system generates a reward in response to usage of the computing resources of the user device. In one example, the system generates at least a portion of a unit of cryptocurrency as a result of validating a pending block on a block chain. In some embodiments, the system may be based around a single form of cryptocurrency, while in other embodiments, the system may be flexible and generate customized currency forms based on the desires of a particular participating entity and the user base.

The generated reward may be collected and stored by at least one of the user and the participating entity associated with the accessed content. By collecting the generated reward for itself, the participating entity is able to uniquely monetize its content. Alternatively, the generated reward may be portioned between the participating entity and the user associated with the leveraged user device. In this way, the user may be incentivized and rewarded for accessing and interacting with the participating entity's content, encouraging additional and/or prolonged interaction. A user's participation within the system may be further incentivized and rewarded by offering increasing rates of return for generated rewards. For example, after the user has participated in the block chain as previously described for a predetermined amount of time (e.g., 6 months), the system may award the user with an increased share of the generated reward (i.e., cryptocurrency). In this way, the system may outline a series of achievements for the user to earn in order to encourage further prolonged interaction with the system and content provided by the participating entities therein.

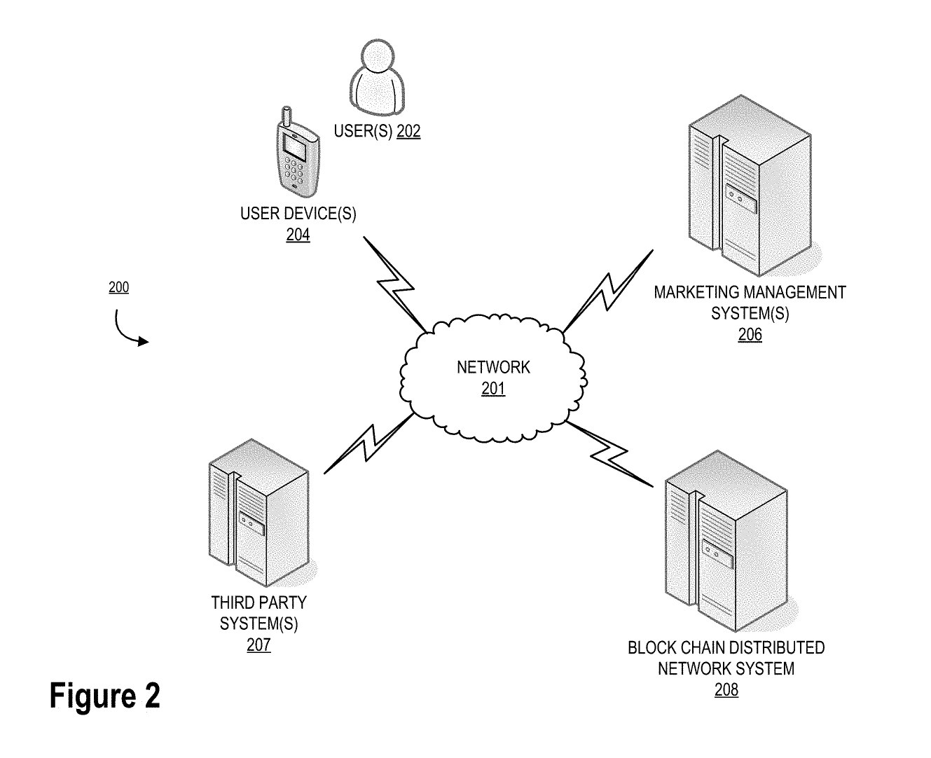

FIG. 2 provides a system that includes specialized systems and devices communicably linked across a distributive network of nodes required to perform the functions of incentivized mining via a network of remote controlled user devices and providing a unified ecosystem for enhanced user-content interaction and currency exchange. FIG. 2 provides an incentivized mining device network system environment 200, in accordance with one embodiment of the present invention. As illustrated in FIG. 2, the block chain distributed network system 208 is operatively coupled, via a network 201 to the user device 204, third party system 207, and to the marketing management system 206. In this way, the block chain distributed network system 208 can send information to and receive information from the user device 204, third party system 207, and the marketing management system 206. FIG. 2 illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is an individual or system that desires to access content provided by an entity and/or generate rewards over the network 201. In other embodiments, a user 202 is an entity, such as a content provider or advertiser, providing content to a user base and leveraging computing resources of one or more user devices over the network 201. In other embodiments a user 202 is a user or entity completing a transaction to be recorded on a block chain. In some embodiments, the user 202 has a user device 204, such as a mobile phone, tablet, or the like that may interact with and control the recordation and validation of blocks on the block chain through interaction with the devices and systems of the environment 200.

It is understood that the servers, systems, and devices described herein illustrate one embodiment of the invention. It is further understood that one or more of the servers, systems, and devices can be combined in other embodiments and still function in the same or similar way as the embodiments described herein.

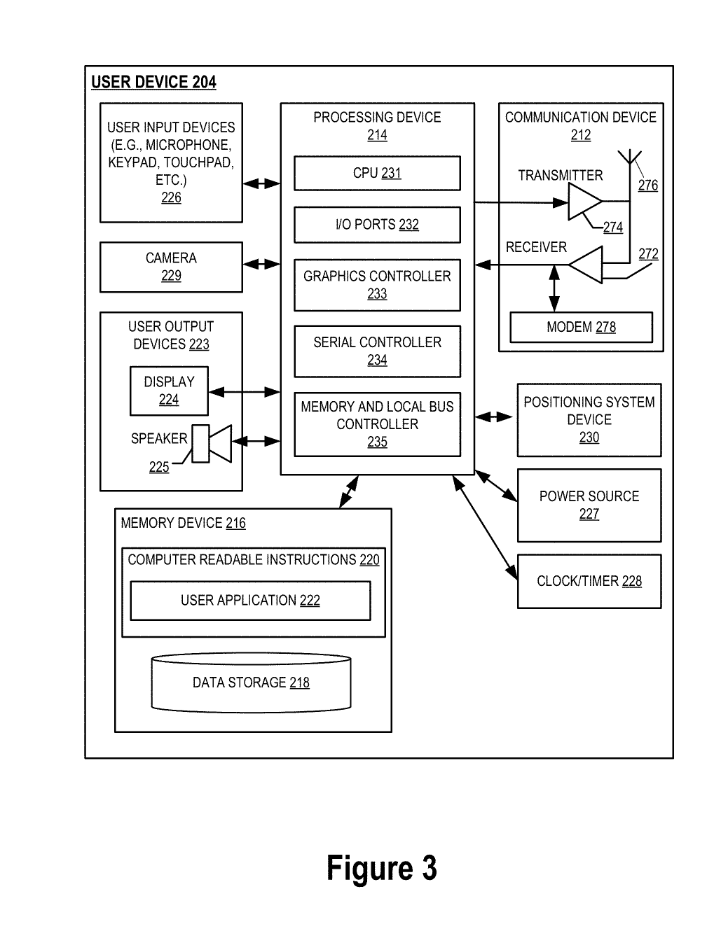

FIG. 3 provides a block diagram of a user device 204, in accordance with one embodiment of the invention. The user device 204 may generally include a processing device or processor 214 communicably coupled to devices such as, a memory device 216, user output devices 223 (for example, a user display device 224, or a speaker 225), user input devices 226 (such as a microphone, keypad, touchpad, touch screen, and the like), a communication device or network interface device 212, a power source 227, a clock or other timer 228, a visual capture device such as a camera 229, a positioning system device 230, such as a geo-positioning system device like a GPS device, an accelerometer, and the like, one or more chips, and the like. The processing device 214 may further include a central processing unit 231, input/output (I/O) port controllers 232, a graphics controller or GPU 233, a serial bus controller 234 and a memory and local bus controller 235.

The processing device 214 may include functionality to operate one or more software programs or applications, which may be stored in the memory device 216. For example, the processing device 214 may be capable of operating applications such as the user application 222. The user application 222 may then allow the user device 204 to transmit and receive data and instructions from the other devices and systems. The user device 204 comprises computer-readable instructions 220 and data storage 218 stored in the memory device 216, which in one embodiment includes the computer-readable instructions 220 of a user application 222. In some embodiments, the user application 222 allows a user 202 to access and/or interact with content provided from an entity. In some embodiments, the user application 222 further includes a mining client for validating blocks on a block chain. The user application 222 may also include a digital wallet or repository for storing, trading, and/or redeeming generated rewards such as cryptocurrency.

The processing device 214 may be configured to use the communication device 212 to communicate with one or more other devices on a network 101 such as, but not limited to the block chain distributed network system 208. In this regard, the communication device 212 may include an antenna 276 operatively coupled to a transmitter 274 and a receiver 272 (together a “transceiver”), modem 278. The processing device 214 may be configured to provide signals to and receive signals from the transmitter 274 and receiver 272, respectively. The signals may include signaling information in accordance with the air interface standard of the applicable BLE standard, cellular system of the wireless telephone network and the like, that may be part of the network 201. In this regard, the user device 204 may be configured to operate with one or more air interface standards, communication protocols, modulation types, and access types. By way of illustration, the user device 204 may be configured to operate in accordance with any of a number of first, second, third, and/or fourth-generation communication protocols and/or the like. For example, the user device 204 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The user device 204 may also be configured to operate in accordance with non-cellular communication mechanisms, such as via a wireless local area network (WLAN) or other communication/data networks. The user device 204 may also be configured to operate in accordance Bluetooth® low energy, audio frequency, ultrasound frequency, or other communication/data networks.

The user device 204 may also include a memory buffer, cache memory or temporary memory device operatively coupled to the processing device 214. Typically, one or more applications 222, are loaded into the temporarily memory during use. As used herein, memory may include any computer readable medium configured to store data, code, or other information. The memory device 216 may include volatile memory, such as volatile Random Access Memory (RAM) including a cache area for the temporary storage of data. The memory device 216 may also include non-volatile memory, which can be embedded and/or may be removable. The non-volatile memory may additionally or alternatively include an electrically erasable programmable read-only memory (EEPROM), flash memory or the like.

Though not shown in detail, the system further includes a marketing management system 206 (as illustrated in FIG. 1) which is connected to the user device 204 and third party systems 207 and may be associated with one or more marketing or advertisement entities or companies. In this way, while only one marketing management system 206 is illustrated in FIG. 1, it is understood that multiple network systems may make up the system environment 200. The marketing management system 206 generally comprises a communication device, a processing device, and a memory device. The marketing management system 206 comprises computer-readable instructions stored in the memory device, which in one embodiment includes the computer-readable instructions of a marketing application. The marketing management system 206 may communicate with the user device 204 and the third party system 207 to provide advertisements and marketing material to the user incorporated or embedded in participating entities' generated content.

The third party system 207 comprises the same or similar features as the user device 204 and the marketing management system 206. The third party system 207 may be maintained by a third party entity such as a business which provides online content to a user base and monetizes said content by participating within the systems described herein as a “participating entity.” In some embodiments, a third party entity may include a financial institution. The third party system 207 further includes computer-readable instructions and data storage stored in the memory device, which in one embodiment includes the computer-readable instructions for one or more applications. In some embodiments, the one or more applications allow for providing access to published content and interacting with the block chain distributed network system 208.

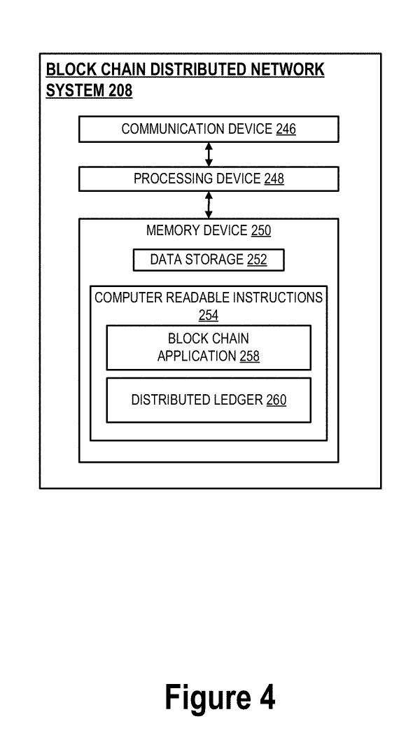

FIG. 4 provides a block diagram of the block chain distributed network system 208, in accordance with one embodiment of the invention. The block chain distributed network system 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the marketing management system 206 and the user device 204. As such, the communication device 246 generally comprises a modem, server, or other device for communicating with other devices on the network 201.

As further illustrated in FIG. 4, the block chain distributed network system 208 comprises computer-readable instructions 254 stored in the memory device 250, which in one embodiment includes the computer-readable instructions 254 of a block chain application 258. In some embodiments, the memory device 250 includes data storage 252 for storing data related to the system environment, but not limited to data created and/or used by the resource application 258.

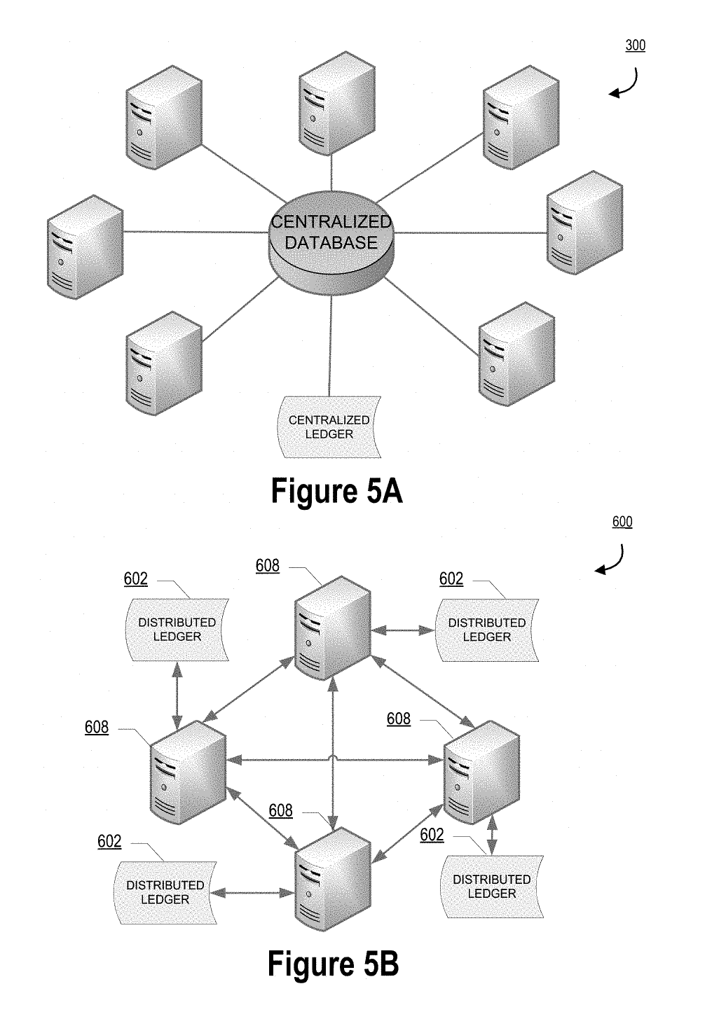

Embodiments of the block chain distributed network system 208 may include multiple systems, servers, computers or the like maintained by one or many entities. FIG. 4 merely illustrates one of those systems that, typically, interacts with many other similar systems to form the block chain. The block chain distributed network system 208 will be outlined below in more detail with respect to FIGS. 5-7. In some embodiments, financial institution systems may be part of the block chain. Similarly, in some embodiments, the block chain distributed network system 208 is part of a financial institution system. In other embodiments, the financial institution system is distinct from the block chain distributed network system 208. The block chain distributed network system 208 may communicate with the financial institution system via a secure connection generated for secure encrypted communications between the two systems.

In one embodiment of the block chain distributed network system 208 the memory device 250 stores, but is not limited to, a block chain application 258 and a distributed ledger 260. In some embodiments, the distributed ledger 260 stores data including, but not limited to, at least portions of a transaction record. In one embodiment of the invention, both the block chain application 258 and the distributed ledger 260 may associate with applications having computer-executable program code that instructs the processing device 248 to operate the network communication device 246 to perform certain communication functions involving described herein. In one embodiment, the computer-executable program code of an application associated with the distributed ledger 260 and block chain application 258 may also instruct the processing device 248 to perform certain logic, data processing, and data storing functions of the application.

The processing device 248 is configured to use the communication device 246 to gather data, such as data corresponding to transactions, blocks or other updates to the distributed ledger 260 from various data sources such as other block chain network system. The processing device 248 stores the data that it receives in its copy of the distributed ledger 260 stored in the memory device 250.

FIG. 5A illustrates a centralized database architecture environment 300, in accordance with one embodiment of the present invention. The centralized database architecture comprises multiple nodes from one or more sources and converge into a centralized database. The system, in this embodiment, may generate a single centralized ledger for data received from the various nodes. FIG. 5B provides a general block chain system environment architecture 600, in accordance with one embodiment of the present invention. Rather than utilizing a centralized database of data for instrument conversion, as discussed above in FIG. 5A, various embodiments of the invention may use a decentralized block chain configuration or architecture as shown in FIG. 5B.

A block chain is a distributed database that maintains a list of data blocks, such as real-time resource availability associated with one or more accounts or the like, the security of which is enhanced by the distributed nature of the block chain. A block chain typically includes several nodes, which may be one or more systems, machines, computers, databases, data stores or the like operably connected with one another. In some cases, each of the nodes or multiple nodes are maintained by different entities. A block chain typically works without a central repository or single administrator. One well-known application of a block chain is the public ledger of transactions for cryptocurrencies. The data blocks recorded in the block chain are enforced cryptographically and stored on the nodes of the block chain.

A block chain provides numerous advantages over traditional databases. A large number of nodes of a block chain may reach a consensus regarding the validity of a transaction contained on the transaction ledger. As such, the status of the instrument and the resources associated therewith can be validated and cleared by one participant.

The block chain system typically has two primary types of records. The first type is the transaction type, which consists of the actual data stored in the block chain. The second type is the block type, which are records that confirm when and in what sequence certain transactions became recorded as part of the block chain. Transactions are created by participants using the block chain in its normal course of business, for example, when someone sends cryptocurrency to another person, and blocks are created by users known as “miners” who use specialized software/equipment to create blocks. In some embodiments, the block chain system is closed, as such the number of miners in the current system are known and the system comprises primary sponsors that generate and create the new blocks of the system. As such, any block may be worked on by a primary sponsor. Users of the block chain create transactions that are passed around to various nodes of the block chain. A “valid” transaction is one that can be validated based on a set of rules that are defined by the particular system implementing the block chain. For example, in the case of cryptocurrencies, a valid transaction is one that is digitally signed, spent from a valid digital wallet and, in some cases that meets other criteria.

As mentioned above and referring to FIG. 5B, a block chain system 600 is typically decentralized—meaning that a distributed ledger 602 (i.e., a decentralized ledger) is maintained on multiple nodes 608 of the block chain 600. One node in the block chain may have a complete or partial copy of the entire ledger or set of transactions and/or blocks on the block chain. Transactions are initiated at a node of a block chain and communicated to the various nodes of the block chain. Any of the nodes can validate a transaction, add the transaction to its copy of the block chain, and/or broadcast the transaction, its validation (in the form of a block) and/or other data to other nodes. This other data may include time-stamping, such as is used in cryptocurrency block chains. In some embodiments, the nodes 608 of the system might be financial institutions that function as gateways for other financial institutions. For example, a credit union might hold the account, but access the distributed system through a sponsor node.

Various other specific-purpose implementations of block chains have been developed. These include distributed domain name management, decentralized crowd-funding, synchronous/asynchronous communication, decentralized real-time ride sharing and even a general purpose deployment of decentralized applications.

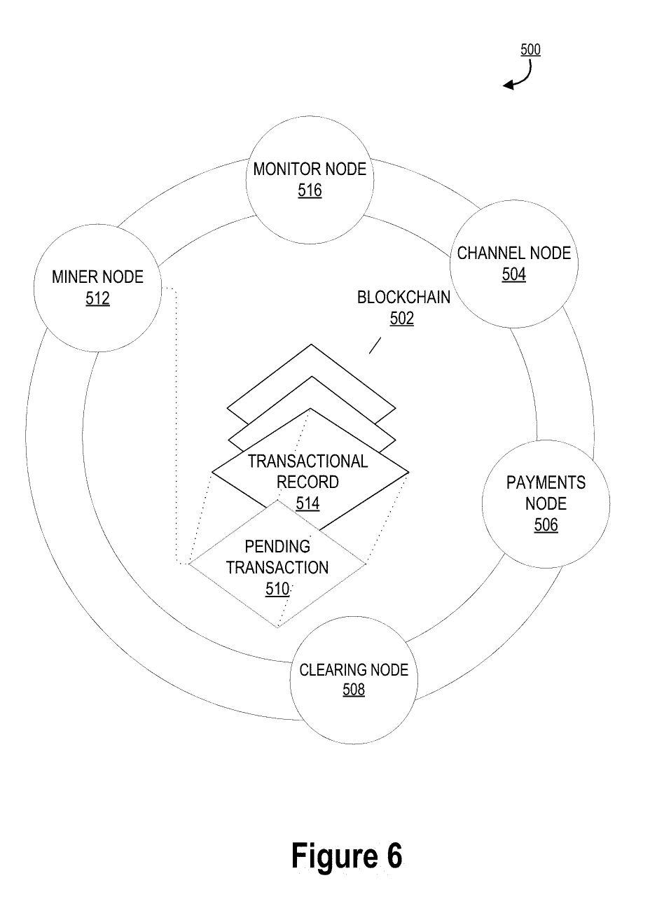

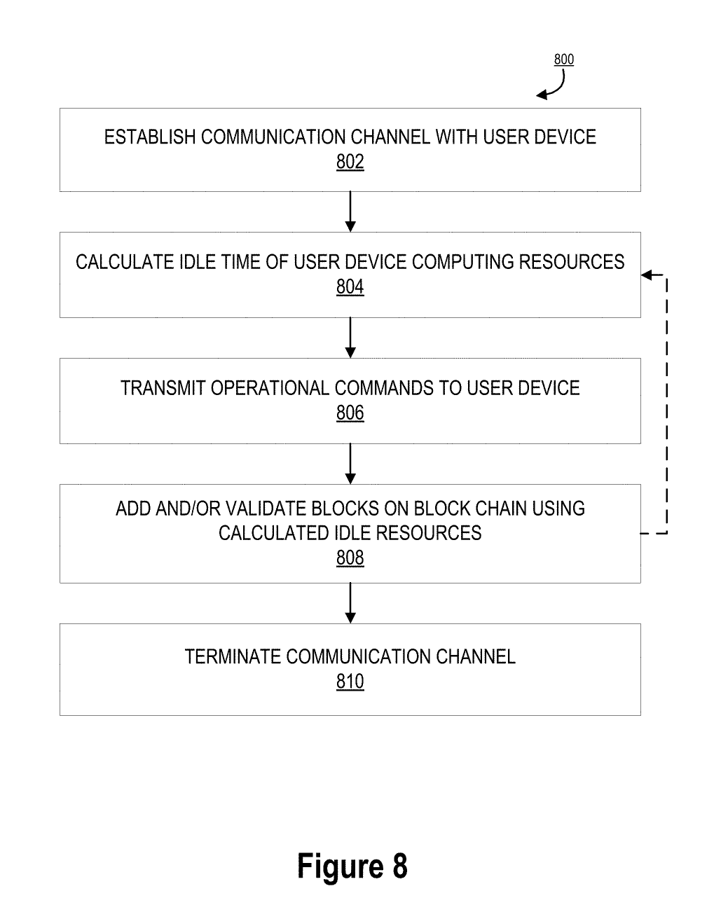

FIG. 6 provides a high level process flow illustrating node interaction within a block chain system environment architecture 500, in accordance with one embodiment of the present invention. As illustrated and discussed above, the block chain system may comprise at least one or more nodes used to generate blocks. In some embodiments, a user's computing device may be leveraged to participate on the block chain as a node while the user is interacting with provided content. Thus, the system may utilize the user's computing device CPU or GPU power that is not being used for visualizing content for participation in the block chain. In a specific embodiment, a user's device may participate on the block chain on the mining level as a miner node. These embodiments are further described in FIG. 1 and FIG. 8.

In some embodiments, the channel node 504, payments node 506, monitor node 516 or the clearing node 508 may publish a pending transaction 510 to the block chain 502. At this stage, the transaction has not yet been validated by the miner node(s) 512, and the other nodes will delay executing their designated processes. The miner node 512 (i.e., the leveraged user device CPU or GPU) may be configured to detect a pending transaction 510. Upon verifying the integrity of the data in the pending transaction 510, the miner node 512 validates the transaction and adds the data as a transactional record 514, which is referred to as a block to the block chain 502. Once a transaction has been authenticated in this manner, the nodes will consider the transactional record 514 to be valid and thereafter execute their designated processes accordingly. The transactional record 514 will provide information about the transaction processed and transmitted through and metadata coded therein for searchability of the transactional record 514 within a distributed ledger. The system may retain one or more rewards or cryptocurrency data associated with the execution of the process and posting of the transactional record. This may later be distributed to one or more users, marketing managers, third parties, or the like.

In some embodiments, the system may comprise at least one additional miner node 512. The system may require that pending transactions 510 be validated by a plurality of miner nodes 512 before becoming authenticated blocks on the block chain. In some embodiments, the systems may impose a minimum threshold number of miner nodes 512 needed. The minimum threshold may be selected to strike a balance between the need for data integrity/accuracy versus expediency of processing. In this way, the efficiency of the computer system resources may be maximized.

Furthermore, in some embodiments, a plurality of computer systems are in operative networked communication with one another through a network. The network may be a system specific distributive network receiving and distributing specific network feeds and identifying specific network associated triggers.

In a specific example, a plurality of user device participating within the ecosystem of the content access and mining system described herein may be leveraged to at least partially participate at a mining level on the block chain. Through connection with the block chain distributed network system, the plurality of user devices may be used in unison or separately as miner nodes to validate transactions on the block chain.

In some embodiments, the computer systems represent the nodes of the block chain, such as the miner node or the like. In such an embodiment, each of the computer systems comprise the block chain, providing for decentralized access to the block chain as well as the ability to use a consensus mechanism to verify the integrity of the data therein. In some embodiments, an upstream system and a downstream system are further operatively connected to the computer systems and each other through the network. The upstream system further comprises a ledger and the block chain. The downstream system further comprises the block chain and an internal ledger, which in turn comprises a copy of the ledger.

In some embodiments, a copy of block chain may be stored on a durable storage medium within the computer systems or the upstream system or the downstream system. In some embodiments, the durable storage medium may be RAM. In some embodiments, the durable storage medium may be a hard drive or flash drive within the system.

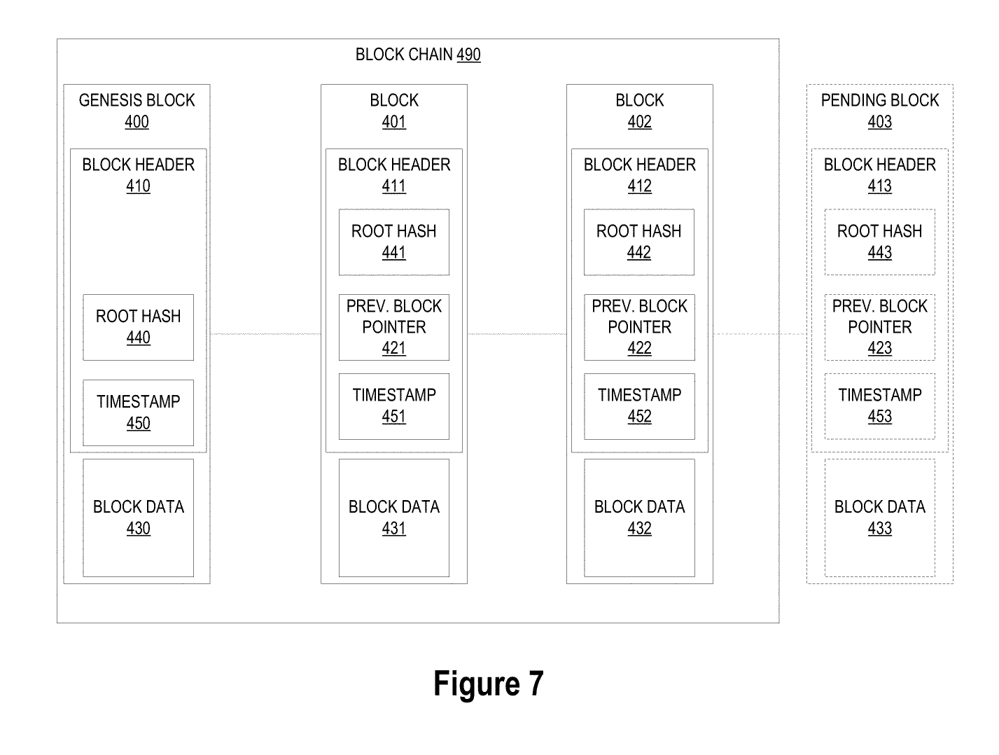

FIG. 7 provides a block diagram illustrating a distributed ledger in more detail. In some embodiments of the invention, the one or more user devices leveraged by the system operate as nodes within a block chain architecture as depicted in FIG. 7 and may be used to validate pending blocks as described herein. FIG. 7 depicts a plurality of blocks 400, 401, and 403 contained in a block chain 490, in addition to a proposed block 403 to be appended to the last block in the block chain 402. Typically, the block chain 490 comprises a genesis block 400 which serves as the first block in the block chain. The genesis block 400, like all other blocks within the block chain 490, comprise a block header 410 and block data 430. Each block data section 430 within a block 400 may contain a wide range of different types of data. For instance, in some embodiments, the block data 430 may comprise electronic files such as documents, media files, and the like. In other embodiments, the block data 430 may contain one or more transactions. The transactions may be, for instance, an exchange or transfer of digital currency. In yet other embodiments, the block data 430 may comprise other data structures, such as pointers provide a link to a file which may exist locally, within another computing system on the network, or on a remote computing system.

The block header 410 may comprise various types of metadata regarding the block data 430. The block header 410 may further comprise a timestamp 450, which in some embodiments may be a Unix timestamp. In some embodiments, particularly in block chains utilizing a PoW consensus mechanism, the block header 410 may comprise a nonce value and a difficulty value. The nonce value is typically the whole number value that results in a hash of the block header 410 that satisfies the difficulty of the cryptographic puzzle as defined by the difficulty value. For instance, the consensus mechanism may require that the resulting hash of the block header 410 metadata falls below a certain value threshold (e.g. the hash must start with a certain number of zeroes, as defined by the difficulty value).

A subsequent block 401 may be appended to the genesis block 400 to serve as the next block in the block chain. Like all other blocks, the subsequent block 401 comprises a block header 411 and block data 431. Similarly, the block header 411 typically comprises a root hash 441 of the data within the block data 431 and a timestamp 451. The block header 411 may further comprise a previous block pointer 421, which is typically a hash calculated by combining the hashes of the metadata (e.g. the root hash 440, timestamp 450, and the like) within the block header 410 of the genesis block 400.

A subsequent block 402 may be appended to the block 401, where the subsequent block 402 also comprises a block header 412 and block data 432. The block header 412 may also comprise a previous block pointer 422 which points to the previous block 401, where the previous block pointer 422 may be a hash value derived by combining the metadata within the block header 411 (including the previous block pointer 421) into a hash algorithm. In this way, the values of each previous block pointer 421, 422 within the block chain are dependent on the hashes of the block headers of all of the previous blocks in the chain; if the block data within any of the blocks is altered, the block header for the altered block as well as all subsequent blocks will result in different hash values. This greatly reduces the risk of improper alteration of data records.

A pending block 403 or “proposed block” may be submitted for addition to the block chain. Once a pending block 403 is submitted to the system, the nodes within the system may validate the pending block 403 via a consensus algorithm. The consensus algorithm may be, for instance, a proof of work mechanism, under which a node determines a nonce value that will result in a hash of the block header 412 of the last block in the block chain which falls under a threshold value. Once said nonce value is determined by one of the nodes in the block chain, the node may post the “solution” to the other nodes in the block chain. Once the solution is validated by the other nodes, the hash of the block header 412 is included in the block header 413 of the pending block 403 as the previous block pointer 423. The pending block 403 is subsequently considered to be appended to the previous block 402 and becomes a part of the block chain 490. In other embodiments, the consensus mechanism may be based on a total number of votes submitted by the nodes of the block chain 490, e.g. a PBFT consensus mechanism. Once a threshold number of votes to validate the pending block 403 has been reached, the pending block 403 may be appended to the block chain 490. In such embodiments, a nonce values and difficulty values may be absent from the block headers.

In one example, the invention utilizes the idle computing resources of the user devices accessing content to operate on a mining level within the block chain as described above. The user devices participate a miner nodes attempt to validate the pending block via a consensus algorithm by computing a nonce value. By determining the “solution” necessary to validate the pending block, a reward (e.g., cryptocurrency) is awarded to the node. Given a large user base accessing content of participating entities, the number of user devices and computing resources made available to participate on the block chain and generate cryptocurrency may be significant.

Arranging a digital ledger in a distributed and decentralized manner across multiple nodes in the manner described herein provides a number of technical advantages over a centralized ledger hosted on a centralized database. For example, because each node hosts a full copy of the distributed ledger, the system does not have a single point of failure, the distributed ledger may continue to be accessible even if one or more nodes fail or are compromised. Furthermore, the block chain structure of the digital ledger ensures that the data records therein are practically immutable, thereby greatly increasing the security and integrity of the data stored in the digital ledger.

FIG. 8 provides a high level process flow illustrating leveraging user device computing resources for block chain mining, in accordance with one embodiment of the invention. As illustrated in block 802, the process 800 is initiated by establishing a communication channel with the user device. The process 800 may receive an access request and provide content to the user device while then leveraging the computing resources of the user device.

As illustrated in block 804 of FIG. 8, the system next calculates the idle time of the user device's computing resources. In some embodiments, the system may be configured to leverage only idle time of the user device so as not to noticeably interfere with executed operations of the device by the user. In this way, the system may leverage the computing resources of the user device discreetly in the background of normal operation of the user device without interrupting the user's experience.

As illustrated in block 806, the system transmits operational commands to the user device over the network and the established communication channel. The commands transmitted to the user device instructs the hardware and/or software of the user device to execute one or more processes. As illustrated in block 808, the system leverages the previously calculated idle resources of the user device to add, validate, or “mine” pending blocks on the block chain as previously described. In a non-limiting embodiment of the invention, the system remotely accesses, instructs, and controls computing resources such as a central processing unit (CPU), graphics processing unit (GPU), filed-programmable gate array (FPGA), application-specific integrated circuit (ASIC), memory, and/or other similar components. In this way, the user device may be operated by the system as a miner node to add or validate pending blocks on the block chain while the user is accessing the provided content. Mining executed by the user device as instructed by the system may be embodied as an additional process executed by the computing resources of the user device (e.g., an application) that may operate in the background of the user device allowing for continued, uninterrupted operation by the user.

As illustrated by the dashed line between blocks 808 and 804, in some embodiments, the system may recalculate the idle time of user device hardware during mining and adjust the amount of borrowed computing power from the user device in order to efficiently maximize and employ available resources. The amount of computing resources employed by the system may fluctuate based on demand from the user for the computing resources of the user device and any other processes or applications being executed by the user device. In one example, the user may execute an additional process on the user device requiring additional computing resources and reducing idle processing time. Alternatively, the user may terminate a process which frees additional computing resources to be potentially leveraged by the system. In response, the system may regularly or continuously recalculate the idle resources of the user device during execution of an operation and transmit new commands for resource usage to the user device based on the calculation and available resources. In this way, the computing resources of the user device may continue to be efficiently leveraged by the system to mine rewards without interfering with or causing a noticeable interruption to other operations or performance of the user device by the user and the full computing potential of the user device may be realized.

Finally, as illustrated in block 810, the system terminates the communication channel with the user device, ceasing mining operations via the computing resources of the user device. In some embodiments, the system may only control the computing resources of the user device as long as the user device is accessing the content, wherein mining operations cease when the user is no longer accessing the content. For example, the system may leverage idle computing resources of the user device while the user is browsing news articles on a participating entity's website. Mining operations utilizing the idle computing resources then cease in response to the user navigating away from the new article.

In an alternative embodiment, the communication channel may not terminate and instead become inactive, for example, when the user is not accessing content. In yet another embodiment, the communication channel may not terminate, and the computing resources of the user device may continue to be leveraged even when the user is not actively accessing content. For example, the computing resources of the user device may be accessed and controlled by the system while the user device is not in use by the user such as while the user device is in sleep-mode or state, while in a charging state, in a locked state, or during a predetermined time period (i.e., according to a predetermined schedule). In some embodiments, the user device may be prevented from accessing content based on the communication channel being terminated or inactive.

By discreetly leveraging the unused or idle computing resources of the user device to mine cryptocurrency while the user is accessing content, as described above, the system is able to provide an alternative method for monetizing the content generated by the participating entity through implementation of the unique technical solution described herein. The system allows for participating entities to avoid typical advertisement incorporation and “clickbait”-focused content creation and instead allow for participating entities to focus on quality content that garners increased user involvement and engagement. Further, by eliminating misleading content, such as deceptive article titles, which can prove frustrating to a user attempting to interact with content, a user's view of the participating entity may be improved encouraging further patronage.

Additionally, due to the increased user involvement and engagement with content, the described system may also be used as a compliment to traditional advertisement. Incentivized and prolonged engagement with content increases user exposure to traditional advertisements, as the user is more likely to spend more time engaged with the content. For example, a user is more likely to see and be impacted by an advertisement embedded in an online news source with which the user is incentivized to have prolonged interaction.

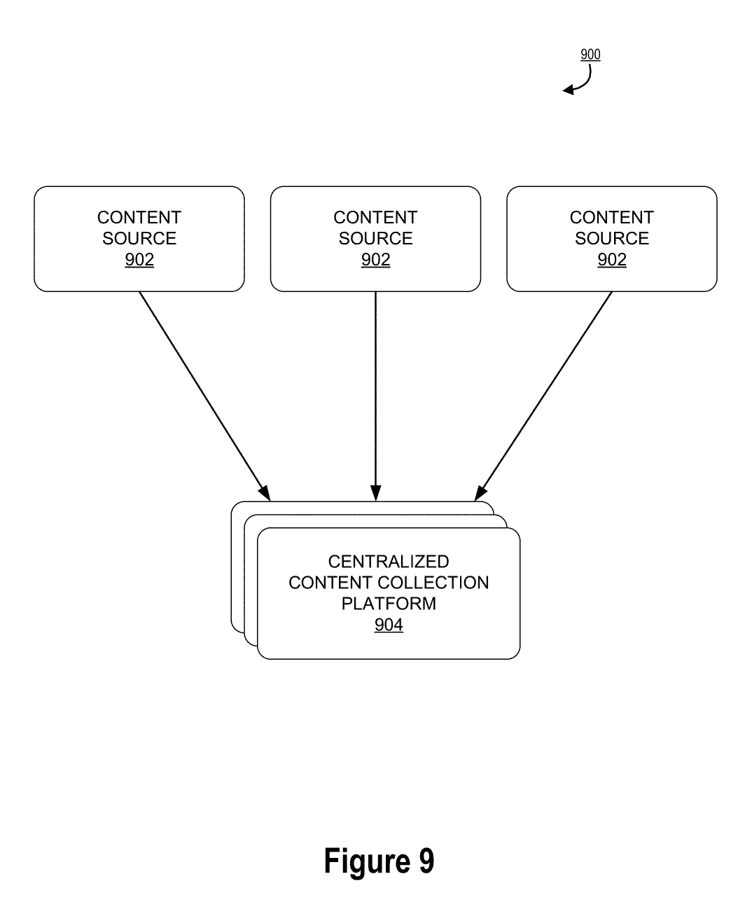

FIG. 9 provides a diagram of a centralized content collection platform 900, in accordance with one embodiment of the invention. The system may be implemented over a network of participating entities to generate a centralized content collection platform 904 from a plurality of content sources 902 provided by a plurality of participating entities. In the illustrated embodiment, the system pulls content from the various content sources 902 provided by participating entities to present the user with the unified content collection platform 904. In some embodiments, the platform 904 may host content provided from various participating entities. In this way, the system may reduce the desire of the user to navigate away from the ecosystem of the invention by providing the user with a collection of varied and/or tailored content. User-retention within the invention ecosystem allows for continued and uninterrupted use of the computing resources of user devices for mining operations and reward generation as described herein.

In another embodiment, the system generates an account and profile associated with the user for tracking user engagement with the system. In some embodiments, the system provides the user with a unified account across a networked ecosystem of participating entities and other third parties. The account may track user reward usage and progress achieved over a plurality of participating entity websites and applications. In one embodiment, the generated account may further provide the user with a digital wallet platform for accumulating and storing digital rewards (e.g., cryptocurrency, rewards points, coupons, rebates, digital items, or the like) collected as a result of the user device mining techniques disclosed herein. Funds may be transferred from the digital wallet to one or more other accounts of the user (e.g., banking accounts). The digital wallet may act as a single repository for rewards accumulated by the user across all participating entity platforms within the system. In some embodiments, the system may generate the digital wallet and store it within the memory of the user device, while in other embodiments, the digital wallet may be stored within the system separate from the user device. Similarly, a digital wallet may be generated for the participating entity to store currency generated from the mining process.

In another embodiment, the system provides a reward exchange platform or marketplace for redeeming rewards or currencies generated by the user device mining system. The exchange platform may provide tangible and/or intangible rewards redeemable by the user in exchange for the generated currency. Tangible rewards may include products, merchandise, and/or services offered by the participating entities and/or other third party entities. Intangible rewards may include digital goods and services such as audio and video downloads, in-app items, subscriptions, or the like. In some embodiments, participating entities and other sponsors may provide discounts or other offers exclusively through the exchange platform to encourage use and patronage. The exchange platform may also act as a currency exchange for earned rewards to be converted or bought and sold to other forms such as cash, gift cards, other forms of cryptocurrency, and the like.

The various components of the system as described herein, such as the content access and mining system, the centralized content collection platform, the digital wallet, and the exchange platform may be embodied as one or more applications or software clients installed on one or more of the devices described herein and in system environment 200 of FIG. 2. In other embodiments, the content access and mining system, the centralized content collection platform, the digital wallet, and the exchange platform may be separate applications.

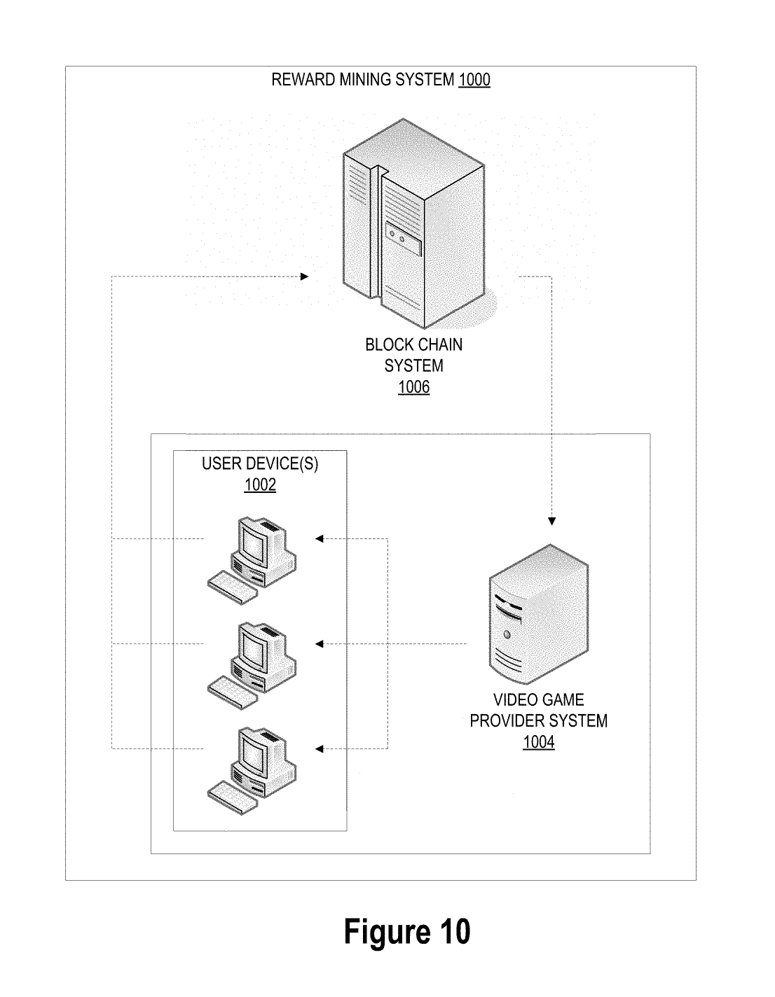

FIG. 10 provides a specific implementation of the content access and mining system described herein as a reward mining system 1000. FIG. 10 provides a video game incentivized reward mining system environment, in accordance with one embodiment of the invention. The user devices 1002 and video game provider system 1004 communicate over a network to allow the user devices 1002 to access a video game (i.e., content) provided by a video game provider system (i.e., the content provider). In some embodiments, the video game may be a free-to-play (F2P) or “freemium” video game or the like that supports in-game purchases (e.g., items, services, additional content, or the like) in exchange for actual and/or in-game currency. In the illustrated embodiment, the reward mining system 1000 leverages and pulls idle computing resources of the user devices 1002 to the block chain system 1006 in order to participate on the block chain at a mining level as previously discussed herein. The idle computing resources of the user devices 1002 may be utilized as miner nodes on the block chain while the user devices 1002 access the video game. Data may be transmitted and received to and from the user devices 1002 and the block chain system 1006 during mining operations and block validation. In the illustrated embodiment, rewards (e.g., cryptocurrency) generated as a result of mining operations, such as successfully validating blocks, may be transferred from the block chain system 1006 to the video game provider system 1004. The video game provider system 1004 may optionally transfer a form of reward back to the user devices 1002 such as in-game rewards (e.g., items, services, content, currency, or the like). In this way, an entity maintaining the video game provider system (e.g., a video game developer, publisher, or the like) may uniquely monetize the video game access by the user devices 1002 while further incentivizing continued use by the user base and possibly forming further spending habits by awarding in-game currency to the users.

In some embodiments, the system may alternatively leverage the computing resources of a second user device associated with a user instead of or in addition to a first user device that is accessing and playing the video game. For example, the user may play the video game on a video game console while the computing resources of the user's mobile device mine cryptocurrency on the block chain.

It should be understood that the previous embodiment of FIG. 10 and providing rewards alternative to actual currency may be applied to various other forms of content consumption as discussed herein. In another specific embodiment, the invention may be implemented in audio, video, or other media streaming service, wherein a user device's computing resources are leveraged by the system to participate on the block chain in exchange for access to the streamed content. For example, the content provider may provide the user with a predetermined number of downloads, a subscription, or the like that is subsidized through the generated rewards (e.g., cryptocurrency) returned from the block chain mining operations. In an alternative embodiment, real-world rewards such as products, services, or the like may be subsidized through user device leveraged block chain mining. For example, a user may receive a new mobile phone for a reduced or subsidized price in exchange for permitting the mobile phone to be leveraged by the system for participation on the block chain at a mining level. In some embodiments, the subsidized device may have discrete hardware and/or software installed on the device for the purpose or optimization of mining. In one embodiment, the user device may include a discrete hardware device configured only for dedicated execution of a mining operation or other operation.

As previously discussed, the system described herein may be based around a single form of cryptocurrency, while in other embodiments, the system may be flexible and generate alternative or customized currency forms based on the desires of a particular participating entity and user base. For example, the system may allow a participating entity to select a preferred form of reward or currency returned by mining operations (e.g., from a drop-down menu within a user interface). In another embodiment, the system may automatically select a returned form of currency based on maximizing profit of the participating entity. The system may continuously monitor and calculate factors such as currency exchange rates, mining hardware energy requirements, and the like in order to select a currency form that maximizes the reward returned to the entity. In some embodiments, the system may shift from a first returned currency form to a second returned currency form during mining operations based on the second returned currency form being determined to be more profitable than the first returned currency form by the system. In some embodiments, the system may return one or more forms of reward or currency to the participating entity simultaneously.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system implementing networked devices for utilizing leveraged computing resources within a content delivery platform, the system comprising:
a memory device with computer-readable program code stored thereon;
a communication device connected to a network; and
a processing device operatively coupled to the memory device and the communication device, wherein the processing device is configured to execute the computer-readable program code to:
establish a communication channel with a user device over the network;
receive a request from the user device to access requested content;
in response to receiving the request from the user device, provide the user device with access to the requested content;
calculate idle computing resources of the user device not used by the user device to access the requested content; and
based on calculating the idle computing resources of the user device and receiving the request, leverage the idle computing resources to execute an operation on a block chain.

2. The system of claim 1, wherein leveraging the idle computing resources further comprises:
transmitting instructions for executing the operation to the user device; and
remotely controlling the idle computing resource of the user device over the network to execute the operation.

3. The system of claim 1, wherein the idle computing resources of the user device comprise hardware installed in the user device configured for executing the operation.

4. The system of claim 3, wherein the hardware of the user device comprises a central processing unit, a graphics processing unit, a field-programmable gate array, an application-specific integrated circuit, or a memory.

5. The system of claim 3, wherein the hardware installed in the user device is a discrete hardware device configured only for dedicated execution of the operation on the block chain.

6. The system of claim 1, wherein the operation is a background operation executed autonomously by the idle computing resources of the user device without requiring user interaction with the user device.

7. The system of claim 1, wherein the processing device is further configured to execute the computer-readable program code to only leverage the idle computing resources of the user device while the user device is accessing the requested content.

8. The system of claim 1, wherein an amount of leveraged idle computing resources is dependent on a user demand for the idle computing resources and other processes executed by user device, wherein execution of the operation using the leveraged idle computing resources does not interfere with execution the other processes.

9. The system of claim 1, wherein the processing device is further configured to execute the computer-readable program code to continuously recalculate the idle computing resources during execution of the operation.

10. The system of claim 1, wherein the processing device is further configured to execute the computer-readable program code to prevent the user device from accessing the requested content in response to termination of the communication channel.

11. The system of claim 1, wherein the processing device is further configured to execute the computer-readable program code to continue leveraging the idle computing resources of the user device when the user device is in an inactive state and the user device is not assessing the requested content.

12. The system of claim 1, wherein the processing device is further configured to execute the computer-readable program code to leverage the idle computing resources during a predetermined period when the user device is not accessing the requested content.

13. The system of claim 1, wherein the user device is a first user device, and wherein the processing device is further configured to execute the computer-readable program code to calculate and leverage computing resources of a second user device instead of or in addition to the idle computing resources of the first user device while the user accessing the requested content on the first user device.

14. The system of claim 1, wherein the processing device is further configured to execute the computer-readable program code to leverage the user device as a miner node and leverage the idle computing resources of the user device to validate a pending block on the block chain.

15. The system of claim 1, wherein executing the operation generates a reward, and wherein the system is further configured to store at least a portion of the reward.

16. A method for implementing networked devices for utilizing leveraged computing resources within a content delivery platform, the method comprising:
establishing a communication channel with a user device over a network;
receiving a request from the user device to access requested content;
in response to receiving the request from the user device, providing the user device with access to the requested content;
calculating idle computing resources of the user device not used by the user device to access the requested content; and
based on calculating the idle computing resources of the user device and receiving the request, leveraging the idle computing resources to execute an operation on a block chain.

17. The method of claim 16, wherein leveraging the idle computing resources further comprises:
transmitting instructions for executing the operation to the user device; and
remotely controlling the idle computing resource of the user device over the network to execute the operation.

18. The method of claim 16, wherein leveraging the idle computing resources of the user device further comprises controlling hardware installed in the user device configured for executing the operation.

19. A system implementing networked devices for utilizing leveraged computing resources within a content delivery platform, the system comprising:
a memory device with computer-readable program code stored thereon;
a communication device connected to a network; and
a processing device operatively coupled to the memory device and the communication device, wherein the processing device is configured to execute the computer-readable program code to:
establish a communication channel with a first user device over the network;
receive a request from the first user device to access requested content;
in response to receiving the request from the first user device, provide the first user device with access to the requested content; and
based on receiving the request and providing the first user device with access to the requested content, leverage the computing resources of a second user device to execute an operation.

20. The system of claim 19, wherein the processing device is further configured to execute the computer-readable program code to:
calculate idle computing resources of the first user device, and
leverage the idle computing resources of the first user device with the computing resources of the second user device to execute the operation.
